(19) United States
(12) Patent Application Publication
(10) Pub. No.: US 2019/0039407 A1
(43) Pub. Date: Feb. 7, 2019

(54) MULTI-FIT WHEEL

(71) Applicant: Oshkosh Corporation, Oshkosh, WI (US)

(72) Inventor: Chad K. Smith, Oshkosh, WI (US)

(73) Assignee: Oshkosh Corporation, Oshkosh, WI (US)

(21) Appl. No.: 16/050,100

(22) Filed: Jul. 31, 2018

Related U.S. Application Data
(60) Provisional application No. 62/540,741, filed on Aug. 3, 2017.

(51) Int. Cl. B60B 3/16; B60B 3/10

(52) U.S. Cl. CPC B60B 3/16; B60B 3/10

(57) ABSTRACT

A multi-fit wheel includes a central portion, a plurality of spokes extending from the central portion, and a lip extending around an outer periphery of the plurality of spokes. The multi-fit wheel defines a plurality of bolt patterns positioned concentrically with the central portion. Each of the plurality of bolt patterns is radially spaced a different distance from a center point of the multi-fit wheel. Each of the plurality of bolt patterns is rotationally offset relative to the other of the plurality of bolt patterns.

### CROSS-REFERENCE TO RELATED PATENT APPLICATIONS

This application claims the benefit of U.S. Provisional Patent Application No. 62/540,741, filed Aug. 3, 2017, which is incorporated herein by reference in its entirety.

### BACKGROUND

Wheels are traditionally designed with a single bolt pattern to fit a desired vehicle. Sometimes, a wheel may be designed with elongated slots that facilitate coupling the wheel to various vehicles having different bolt patterns.

### SUMMARY

One embodiment relates to a multi-fit wheel. The multi-fit wheel includes a central portion, a plurality of spokes extending from the central portion, and a lip extending around an outer periphery of the plurality of spokes. The multi-fit wheel defines a plurality of bolt patterns positioned concentrically with the central portion. Each of the plurality of bolt patterns is radially spaced a different distance from a center point of the multi-fit wheel. Each of the plurality of bolt patterns is rotationally offset relative to the other of the plurality of bolt patterns.

Another embodiment relates to a wheel. The wheel includes a plurality of bolt patterns positioned concentrically about a center of the wheel. The plurality of bolt patterns includes a first bolt pattern having a first plurality of lug apertures radially spaced a first distance from the center of the wheel. One of the first plurality of lug apertures is radially offset from a vertical axis of the wheel by a first angle. The plurality of bolt patterns includes a second bolt pattern having a second plurality of lug apertures radially spaced a second distance from the center of the wheel that is greater than the first distance. One of the second plurality of lug apertures is radially offset from the vertical axis of the wheel by a second angle that is different than the first angle.

Still another embodiment relates to a wheel. The wheel includes a first plurality of apertures and a second plurality of aperture. The first plurality of apertures are positioned to facilitate selectively coupling the wheel to a first wheel hub having a first bolt pattern. The second plurality of apertures distinct from the first plurality of apertures. The second plurality of apertures are positioned to facilitate selectively coupling the wheel to a second wheel hub having a second, different bolt pattern.

The invention is capable of other embodiments and of being carried out in various ways. Alternative exemplary embodiments relate to other features and combinations of features as may be recited herein.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a side view of a vehicle, according to an exemplary embodiment; and

FIGS. 2-6 are various views of a wheel of the vehicle of FIG. 1 having a plurality of bolt patterns, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

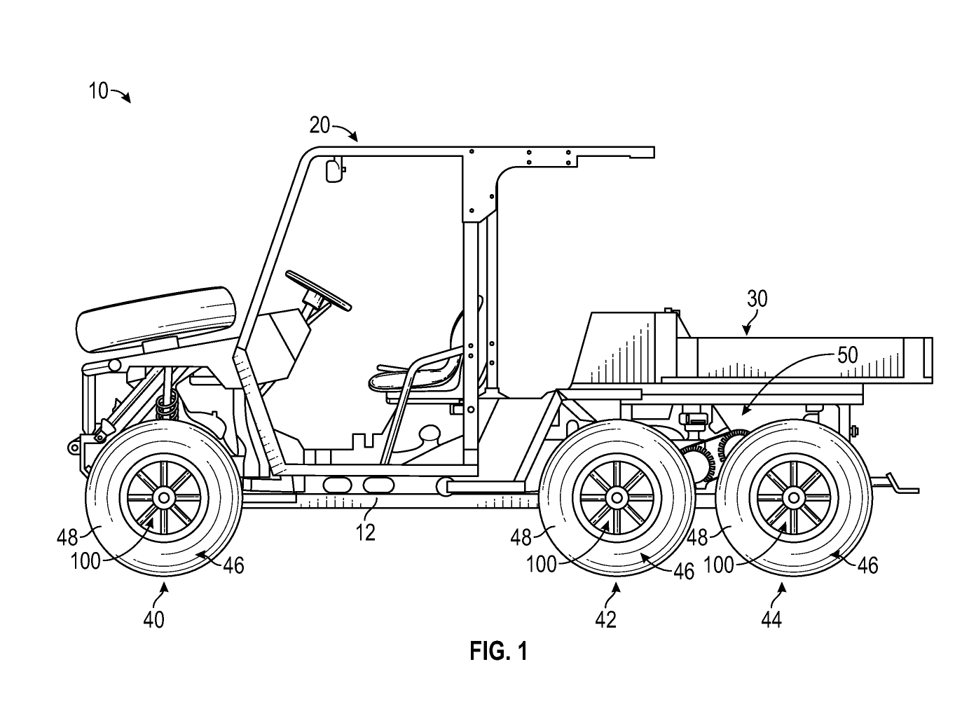

According to the exemplary embodiment shown in FIG. 1, a vehicle, shown as vehicle 10, includes a chassis, shown as frame 12, that supports a body assembly including a first portion, shown as front cabin 20, and a second portion, shown as cargo bed 30. As shown in FIG. 1, the cargo bed 30 is disposed behind the front cabin 20. According to the exemplary embodiment shown in FIG. 1, the vehicle 10 is a utility task vehicle (“UTV”). In other embodiments, the vehicle 10 is another type of vehicle such as a recreational off-highway vehicle, an all-terrain vehicle (“ATV”), a sport utility vehicle (“SUV”), a golf cart, and/or still another vehicle. In still other embodiments, the vehicle 10 is another type of vehicle such as a boom lift and/or a scissor lift.

According to an exemplary embodiment, the frame 12 defines a longitudinal axis. The longitudinal axis may be generally aligned with a frame rail of the frame 12 of the vehicle 10 (e.g., front-to-back, etc.). As shown in FIG. 1, the frame 12 of the vehicle 10 engages a plurality of axles, shown as front axle 40, first rear axle 42, and second rear axle 44. In other embodiments, the vehicle 10 includes only one of the first rear axle 42 and the second rear axle 44. As shown in FIG. 1, each of the front axle 40, the first rear axle 42, and the second rear axle 44 includes tractive assemblies, shown as wheel and tire assemblies 46. In one embodiment, the wheel and tire assemblies 46 each have a tire, shown as tire 48, and a wheel, shown as multi-fit wheel 100. The front axle 40, the first rear axle 42, and the second rear axle 44 may additionally include brakes (e.g., disc brakes, drum brakes, air brakes, etc.), gear reductions, steering components, wheel hubs, suspension components, and/or other features.

According to an exemplary embodiment, the front cabin 20 includes openings in the lateral sides thereof that facilitate entering and exiting an interior of the front cabin 20. In some embodiments, the vehicle 10 includes one or more doors that selectively open and close the openings. The interior of the front cabin 20 may include a plurality of seats (e.g., two, three, four, five, etc.), vehicle controls, driving components (e.g., steering wheel, accelerator pedal, brake pedal, etc.), etc. The cargo bed 30 may include a truck bed or a flat bed. In some embodiments, the cargo bed 30 is pivotable about the rear end of the vehicle 10 to facilitate dumping the contents therein or thereon out of the cargo bed 30.

As shown in FIG. 1, the vehicle 10 includes a powertrain system, shown as powertrain 50. The powertrain 50 may include a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. As shown in FIG. 1, the powertrain 50 is coupled to the frame 12 of the vehicle 10 beneath and/or at least partially beneath the cargo bed 30. In other embodiments, the powertrain 50 is otherwise positioned (e.g., underneath the hood of the vehicle 10, etc.). The powertrain 50 of the vehicle 10 may be a hybrid powertrain, an electric powertrain, or a non-hybrid/non-electric powertrain. According to an exemplary embodiment, the prime mover of the powertrain 50 is a spark-ignition internal combustion engine that utilizes gasoline fuel. In alternative embodiments, the prime mover is another type of device (e.g., a compression-ignition engine, a fuel cell, an electric motor, etc.) that is otherwise powered (e.g., with diesel, compressed natural gas, hydrogen, electricity, etc.). The prime mover of the powertrain 50 may receive fuel (e.g., gasoline, diesel, etc.) from a fuel tank and combust the fuel to generate mechanical energy. In some embodiments, a transmission of the vehicle 10 is rotationally coupled to the prime mover, a transfer case assembly, and/or one or more drive shafts. The one or more drive shafts may be received by one or more differentials configured to convey the rotational energy of the drive shaft to a final drive (e.g., half-shafts of the axles that are coupled to the wheel and tire assemblies 46, etc.). The final drive may then propel or move the vehicle 10.

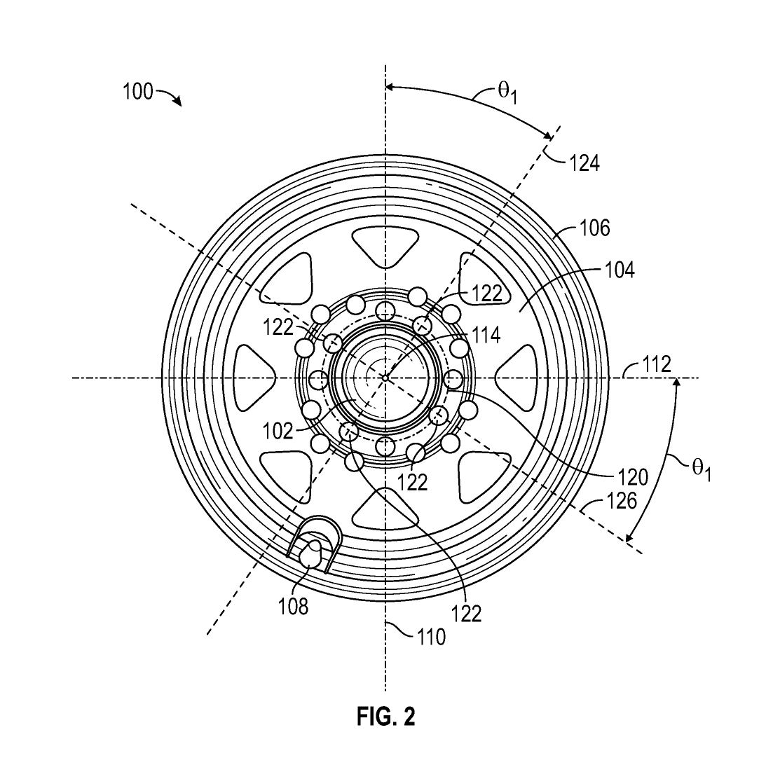

According to the exemplary embodiment shown in FIGS. 2-6, the multi-fit wheel 100 includes an origin (e.g., a central bore, etc.), shown as central portion 102, with a plurality of spokes, shown as spokes 104, extending therefrom, and a lip, shown as rim lip 106, extending around the outer periphery of the spokes 104. The rim lip 106 is configured to interface with a respective tire 48 when the tire 48 is seated on the multi-fit wheel 100. As shown in FIGS. 2-6, the multi-fit wheel 100 defines an aperture, shown as valve stem hole 108. The valve stem hole 108 is configured to receive a valve stem that facilitates filling a gas (e.g., air, nitrogen, etc.) into and expelling the gas from an internal cavity defined between the multi-fit wheel 100 and the tire 48. As shown in FIGS. 2-6, the multi-fit wheel 100 defines a first axis, shown as vertical axis 110, and a second axis, shown as horizontal axis 112, that intersects with vertical axis 110 at a center point, shown as center point 114, of the multi-fit wheel 100. In one embodiment, vertical axis 110 and horizontal axis 112 are perpendicular.

The multi-fit wheel 100 may be manufactured using a casting process, a forging process, a flow forming process, and/or still another suitable wheel manufacturing process. The multi-fit wheel 100 may be manufactured from aluminum, magnesium, steel, iron, metal alloys, carbon fiber, etc. The multi-fit wheel 100 may have a monoblock structure (e.g., a single, unitary structure, a one-piece wheel, etc.) and/or a multi-piece structure (e.g., a two-piece wheel, a three-piece wheel, etc.). In one embodiment, the multi-fit wheel 100 has a diameter of twelve inches. In another embodiment, the multi-fit wheel 100 has a diameter of fourteen inches. In still another embodiment, the multi-fit wheel 100 has a diameter of fifteen inches. In still other embodiments, the multi-fit wheel 100 has a diameter of between ten inches and twenty-four inches. The diameter, width, and/or offset of the multi-fit wheel 100 may be particularly designed to suit vehicle 10.

As shown in FIGS. 2-6, the multi-fit wheel 100 defines a plurality of different bolt patterns (e.g., one or more bolt circle diameters, etc.) concentrically positioned about the central portion 102 of the multi-fit wheel 100. According to an exemplary embodiment, the plurality of different bolt patterns facilitate fitting the multi-fit wheel 100 onto a plurality of different vehicles having different original equipment manufacturer (“OEM”) bolt patterns. Vehicle manufacturers (e.g., UTV OEMs, ATV OEMs, golf cart OEMs, etc.) use a variety of bolt patterns. Rental companies purchase vehicles (e.g., UTVs, ATVs, golf carts, etc.) from many different OEMs. When a tire of a wheel is damaged, a rental company could separate the damaged tire from the wheel, but rather instead the rental company will replace the entire wheel and tire assembly. As such, rental companies traditionally stock spare wheels having each OEM's bolt pattern to have available spare tires. Stocking unique wheels is inefficient and requires repair technicians to bring multiple wheel and tire assemblies to a jobsite when a damaged tire is reported.

As shown in FIG. 2, the multi-fit wheel 100 defines a first bolt pattern, shown as first bolt pattern 120, positioned concentrically with the central portion 102 and radially spaced from the center point 114. The first bolt pattern 120 includes a first plurality of apertures, shown as first lug holes 122, spaced uniformly about the first bolt pattern 120. According to the exemplary embodiment shown in FIG. 2, the first bolt pattern 120 includes four first lug holes 122 that are radially spaced a first distance from the center point 114. In one embodiment, the first lug holes 122 are spaced the first distance such that the first bolt pattern 120 has a first diameter of 110 millimeters (“mm”). The first bolt pattern 120 may thereby be a 4×110 bolt pattern. In other embodiments, the first bolt pattern 120 includes a different number of first lug holes 122 (e.g., three, five, six, eight, etc.) and/or the first lug holes 122 are radially spaced a different distance from the center point 114 such that the first bolt pattern 120 has a different diameter (e.g., less than 110 mm, greater than 110 mm, a diameter between 100 mm and 170 mm, etc.).

As shown in FIG. 2, a first pair of opposing first lug holes 122 are disposed along a first axis, shown as first axis 124, and a second pair of opposing first lug holes 122 are disposed along a second axis, shown as second axis 126. The first axis 124 is rotationally offset from the vertical axis 110 and the second axis 126 is rotationally offset from the horizontal axis 112 by a first angle θ₁ such that the first lug holes 122 of the first bolt pattern 120 are rotationally offset relative to the vertical axis 110 and the horizontal axis 112. According to an exemplary embodiment, the first angle θ₁ is about 30-40 degrees (e.g., 33.75 degrees, etc.). In other embodiments, the first angle θ₁ is between 0 degrees and 85 degrees.

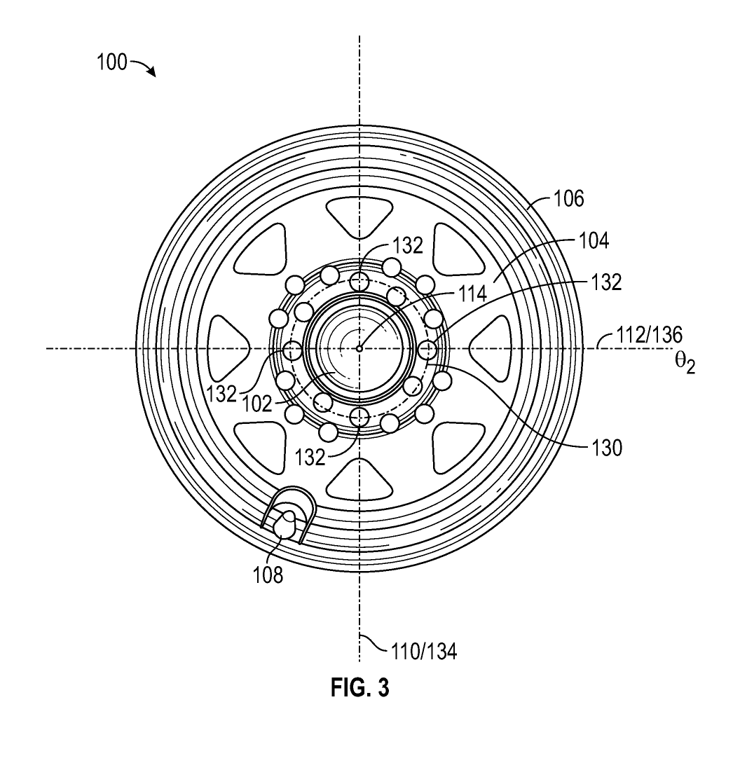

As shown in FIG. 3, the multi-fit wheel 100 defines a second bolt pattern, shown as second bolt pattern 130, positioned concentrically with the central portion 102 and the first bolt pattern 120, and radially spaced from the center point 114. The second bolt pattern 130 includes a second plurality of apertures, shown as second lug holes 132, spaced uniformly about the second bolt pattern 130. According to the exemplary embodiment shown in FIG. 3, the second bolt pattern 130 includes four second lug holes 132 that are radially spaced a second distance from the center point 114. In one embodiment, the second lug holes 132 are spaced the second distance such that the second bolt pattern 130 has a second diameter of 115 mm. The second bolt pattern 130 may thereby be a 4×115 bolt pattern. In other embodiments, the second bolt pattern 130 includes a different number of second lug holes 132 (e.g., three, five, six, eight, etc.) and/or the second lug holes 132 are radially spaced a different distance from the center point 114 such that the second bolt pattern 130 has a different diameter (e.g., less than 115 mm, greater than 115 mm, a diameter between 100 mm and 170 mm, etc.).

As shown in FIG. 3, a first pair of opposing second lug holes 132 are disposed along a first axis, shown as first axis 134, and a second pair of opposing second lug holes 132 are disposed along a second axis, shown as second axis 136. The first axis 134 is coincident with the vertical axis 110 and the second axis 136 is coincident with the horizontal axis 112 such that the second lug holes 132 of the second bolt pattern 130 are rotationally offset relative to the first lug holes 122. In other embodiments, the first axis 134 is rotationally offset from the vertical axis 110 and the second axis 136 is rotationally offset from the horizontal axis 112 by a second angle θ₂ such that the second lug holes 132 of the second bolt pattern 130 are rotationally offset relative to the vertical axis 110, the horizontal axis 112, and the first lug holes 122. The second angle θ₂ may be between 0 degrees and 85 degrees.

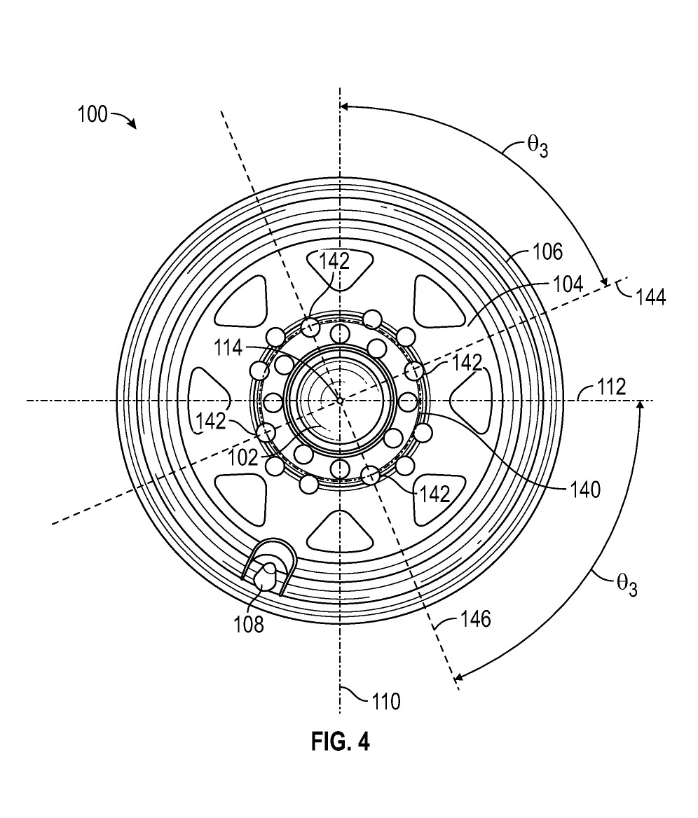

As shown in FIG. 4, the multi-fit wheel 100 defines a third bolt pattern, shown as third bolt pattern 140, positioned concentrically with the central portion 102, the first bolt pattern 120, and the second bolt pattern 130, and radially spaced from the center point 114. The third bolt pattern 140 includes a third plurality of apertures, shown as third lug holes 142, spaced uniformly about the third bolt pattern 140. According to the exemplary embodiment shown in FIG. 4, the third bolt pattern 140 includes four third lug holes 142 that are radially spaced a third distance from the center point 114. In one embodiment, the third lug holes 142 are spaced the third distance such that the third bolt pattern 140 has a third diameter of 137 mm. The third bolt pattern 140 may thereby be a 4×137 bolt pattern. In other embodiments, the third bolt pattern 140 includes a different number of third lug holes 142 (e.g., three, five, six, eight, etc.) and/or the third lug holes 142 are radially spaced a different distance from the center point 114 such that the third bolt pattern 140 has a different diameter (e.g., less than 137 mm, greater than 137 mm, a diameter between 100 mm and 170 mm, etc.).

As shown in FIG. 4, a first pair of opposing third lug holes 142 are disposed along a first axis, shown as first axis 144, and a second pair of opposing third lug holes 142 are disposed along a second axis, shown as second axis 146. The first axis 144 is rotationally offset from the vertical axis 110 and the second axis 146 is rotationally offset from the horizontal axis 112 by a third angle θ₃ such that the third lug holes 142 of the third bolt pattern 140 are rotationally offset relative to the vertical axis 110, the horizontal axis 112, the first lug holes 122, and the second lug holes 132. According to an exemplary embodiment, the third angle θ₃ is about 60-75 degrees (e.g., 67.5 degrees, etc.). In other embodiments, the third angle θ₃ is between 0 degrees and 85 degrees.

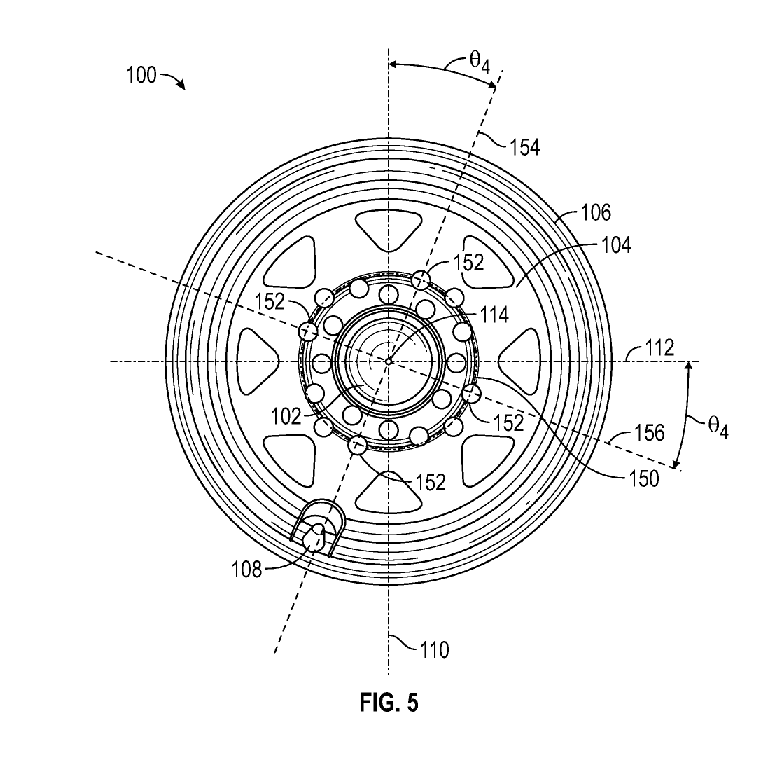

As shown in FIG. 5, the multi-fit wheel 100 defines a fourth bolt pattern, shown as fourth bolt pattern 150, positioned concentrically with the central portion 102, the first bolt pattern 120, the second bolt pattern 130, and the third bolt pattern 140, and radially spaced from the center point 114. The fourth bolt pattern 150 includes a fourth plurality of apertures, shown as fourth lug holes 152, spaced uniformly about the fourth bolt pattern 150. According to the exemplary embodiment shown in FIG. 5, the fourth bolt pattern 150 includes four fourth lug holes 152 that are radially spaced a fourth distance from the center point 114. In one embodiment, the fourth lug holes 152 are spaced the fourth distance such that the fourth bolt pattern 150 has a fourth diameter of 150 mm. The fourth bolt pattern 150 may thereby be a 4×150 bolt pattern. In other embodiments, the fourth bolt pattern 150 includes a different number of fourth lug holes 152 (e.g., three, five, six, eight, etc.) and/or the fourth lug holes 152 are radially spaced a different distance from the center point 114 such that the fourth bolt pattern 150 has a different diameter (e.g., less than 150 mm, greater than 150 mm, a diameter between 100 mm and 170 mm, etc.).

As shown in FIG. 5, a first pair of opposing fourth lug holes 152 are disposed along a first axis, shown as first axis 154, and a second pair of opposing fourth lug holes 152 are disposed along a second axis, shown as second axis 156. The first axis 154 is rotationally offset from the vertical axis 110 and the second axis 156 is rotationally offset from the horizontal axis 112 by a fourth angle θ₄ such that the fourth lug holes 152 of the fourth bolt pattern 150 are rotationally offset relative to the vertical axis 110, the horizontal axis 112, the first lug holes 122, the second lug holes 132, and the third lug holes 142. According to an exemplary embodiment, the fourth angle θ₄ is about 15-30 degrees (e.g., 22.5 degrees, etc.). In other embodiments, the fourth angle θ₄ is between 0 degrees and 85 degrees.

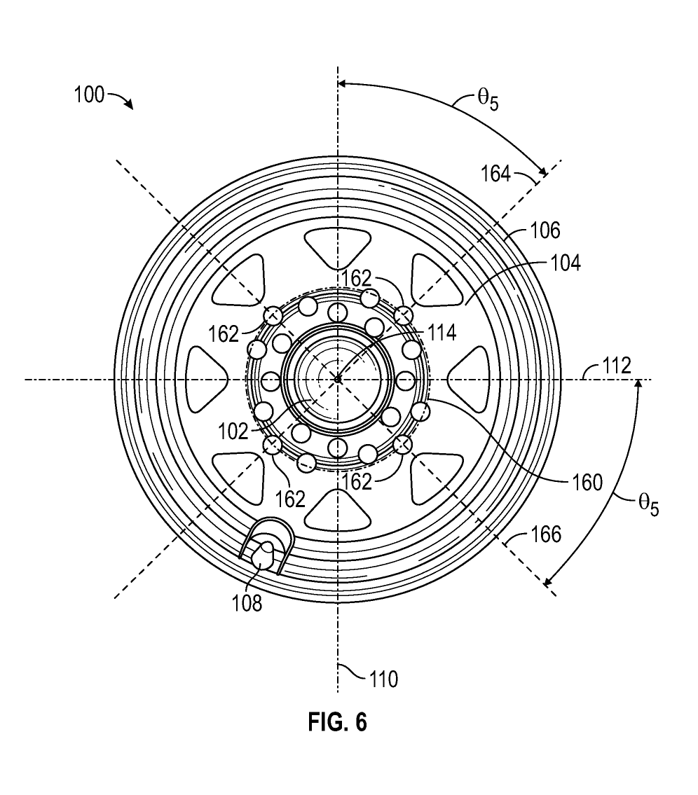

As shown in FIG. 6, the multi-fit wheel 100 defines a fifth bolt pattern, shown as fifth bolt pattern 160, positioned concentrically with the central portion 102, the first bolt pattern 120, the second bolt pattern 130, the third bolt pattern 140, and the fourth bolt pattern 150, and radially spaced from the center point 114. The fifth bolt pattern 160 includes a fifth plurality of apertures, shown as fifth lug holes 162, spaced uniformly about the fifth bolt pattern 160. According to the exemplary embodiment shown in FIG. 6, the fifth bolt pattern 160 includes four fifth lug holes 162 that are radially spaced a fifth distance from the center point 114. In one embodiment, the fifth lug holes 162 are spaced the fifth distance such that the fifth bolt pattern 160 has a fifth diameter of 156 mm. The fifth bolt pattern 160 may thereby be a 4×156 bolt pattern. In other embodiments, the fifth bolt pattern 160 includes a different number of fifth lug holes 162 (e.g., three, five, six, eight, etc.) and/or the fifth lug holes 162 are radially spaced a different distance from the center point 114 such that the fifth bolt pattern 160 has a different diameter (e.g., less than 156 mm, greater than 156 mm, a diameter between 100 mm and 170 mm, etc.).

As shown in FIG. 6, a first pair of opposing fifth lug holes 162 are disposed along a first axis, shown as first axis 164, and a second pair of opposing fifth lug holes 162 are disposed along a second axis, shown as second axis 166. The first axis 164 is rotationally offset from the vertical axis 110 and the second axis 166 is rotationally offset from the horizontal axis 112 by a fifth angle θ₅ such that the fifth lug holes 162 of the fifth bolt pattern 160 are rotationally offset relative to the vertical axis 110, the horizontal axis 112, the first lug holes 122, the second lug holes 132, the third lug holes 142, and the fourth lug holes 152. According to an exemplary embodiment, the fifth angle θ₅ is about 45 degrees. In other embodiments, the fifth angle θ₅ is between 0 degrees and 85 degrees.

According to the exemplary embodiment shown in FIGS. 2-6, the multi-fit wheel 100 includes five unique bolt patterns, each having four lug apertures and configured to fit various vehicles. In other embodiments, the multi-fit wheel 100 includes a different number of bolt patterns. By way of example, the multi-fit wheel 100 may include two bolt patterns, three bolt patterns, four bolt patterns, five bolt patterns, six bolt patterns, etc. Also, the bolt patterns of the multi-fit wheel 100 may include a different number of lug apertures. By way of example, one or more of the bolt patterns of the multi-fit wheel 100 may include three lug apertures, four lug apertures, five lug apertures, six lug apertures, eight lug apertures, etc. By way of another example, the multi-fit wheel 100 may include bolt patterns having differing number of lug apertures. For example, the multi-fit wheel 100 may include one or more bolt patterns having three lug apertures, one or more bolt patterns having four lug apertures, one or more bolt patterns having five lug apertures, one or more bolt patterns having six lug apertures, one or more bolt patterns having eight lug apertures, etc.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

1. A multi-fit wheel comprising:
a central portion;
a plurality of spokes extending from the central portion; and
a lip extending around an outer periphery of the plurality of spokes;
wherein the multi-fit wheel defines a plurality of bolt patterns positioned concentrically with the central portion;
wherein each of the plurality of bolt patterns is radially spaced a different distance from a center point of the multi-fit wheel; and
wherein each of the plurality of bolt patterns is rotationally offset relative to the other of the plurality of bolt patterns.

2. The multi-fit wheel of claim 1, wherein the multi-fit wheel defines at least three different bolt patterns.

3. The multi-fit wheel of claim 2, wherein the multi-fit wheel defines at least four different bolt patterns.

4. The multi-fit wheel of claim 3, wherein the multi-fit wheel defines at least five different bolt patterns.

5. The multi-fit wheel of claim 1, wherein each of the plurality of bolt patterns has a plurality of lug apertures.

6. The multi-fit wheel of claim 5, wherein the plurality of lug apertures of each of the plurality of bolt patterns has the same number of lug apertures.

7. The multi-fit wheel of claim 5, wherein at least one of the plurality of bolt patterns has a different number of lug apertures than the other of the plurality of bolt patterns.

8. A wheel comprising:
a plurality of bolt patterns positioned concentrically about a center of the wheel, the plurality of bolt patterns including:
a first bolt pattern having a first plurality of lug apertures radially spaced a first distance from the center of the wheel, wherein one of the first plurality of lug apertures is radially offset from a vertical axis of the wheel by a first angle; and
a second bolt pattern having a second plurality of lug apertures radially spaced a second distance from the center of the wheel that is greater than the first distance, wherein one of the second plurality of lug apertures is radially offset from the vertical axis of the wheel by a second angle that is different than the first angle.

9. The wheel of claim 8, wherein the plurality of bolt patterns includes a third bolt pattern having a third plurality of lug apertures radially spaced a third distance from the center of the wheel that is greater than the first distance and the second distance, wherein one of the third plurality of lug apertures is radially offset from the vertical axis of the wheel by a third angle that is different than the first angle and the second angle.

10. The wheel of claim 9, wherein the plurality of bolt patterns includes a fourth bolt pattern having a fourth plurality of lug apertures radially spaced a fourth distance from the center of the wheel that is greater than the first distance, the second distance, and the third distance, wherein one of the fourth plurality of lug apertures is radially offset from the vertical axis of the wheel by a fourth angle that is different than the first angle, the second angle, and the third angle.

11. The wheel of claim 10, wherein the plurality of bolt patterns includes a fifth bolt pattern having a fifth plurality of lug apertures radially spaced a fifth distance from the center of the wheel that is greater than the first distance, the second distance, the third distance, and the fourth distance, wherein one of the fifth plurality of lug apertures is radially offset from the vertical axis of the wheel by a fifth angle that is different than the first angle, the second angle, the third angle, and the fourth angle.

12. The wheel of claim 11, wherein the first bolt pattern has a first diameter of about 110 millimeters, the second bolt pattern has a second diameter of about 115 millimeters, the third bolt pattern has a third diameter of about 137 millimeters, the fourth bolt pattern has a fourth diameter of about 150 millimeters, and the fifth bolt pattern has a fifth diameter of about 156 millimeters.

13. The wheel of claim 11, wherein the first angle is between 30 and 40 degrees, the second angle is about 0 degrees, the third angle is between 60 and 75 degrees, the fourth angle is between 15 and 30 degrees, and the fifth angle is about 45 degrees.

14. The wheel of claim 8, wherein the first plurality of lug apertures has the same number of lug apertures as the second plurality of lug apertures.

15. The wheel of claim 8, wherein the first plurality of lug apertures has a different number of lug apertures than the second plurality of lug apertures.

16. A wheel comprising:
a first plurality of apertures positioned to facilitate selectively coupling the wheel to a first wheel hub having a first bolt pattern; and
a second plurality of apertures distinct from the first plurality of apertures, the second plurality of apertures positioned to facilitate selectively coupling the wheel to a second wheel hub having a second, different bolt pattern.

17. The wheel of claim 16, wherein the first bolt pattern has a first diameter and the second, different bolt pattern has a second, different diameter.

18. The wheel of claim 16, wherein each of the first plurality of apertures is rotationally offset from a respective one of the second plurality of apertures.

19. The wheel of claim 16, wherein the first plurality of apertures has a first number of apertures and the second plurality of apertures has a second, different number of apertures.

20. The wheel of claim 16, further comprising a third plurality of apertures distinct from the first plurality of apertures and the second plurality of apertures, the third plurality of apertures positioned to facilitate selectively coupling the wheel to a third wheel hub having a third, different bolt pattern.
